(19) United States
(12) Patent Application Publication
(10) Pub. No.: US 2026/0135581 A1
(43) Pub. Date: May 14, 2026

(54) ADAPTIVE CROSS POLARIZATION INTERFERENCE MITIGATION

(71) Applicant: Hughes Network Systems, LLC, Germantown, MD (US)

(72) Inventors: Channasandra Ravishankar, Clarksburg, MD (US); Xiaoling Huang, Boyds, MD (US)

(21) Appl. No.: 19/274,813

(22) Filed: Jul. 21, 2025

Related U.S. Application Data
(60) Provisional application No. 63/720,445, filed on Nov. 14, 2024.

(51) Int. Cl. H04B 1/12; H01Q 1/28

(52) U.S. Cl. CPC H04B 1/12; H01Q 1/288

(57) ABSTRACT

Various arrangements for cross-polarization interference mitigation are detailed herein. A baseline cross-polarization interference density limits of a user terminal (UT) and a baseline throughput of the UT can be determined. An adjustment value can then be determined for an intended polarization (co-pol) isotropic radiated power (EIRP) density, such that the cross-polarization (x-pol) interference density limits are not exceeded. After determining the baseline throughput, an effective co-pol EIRP density of the UT can be set based on the adjustment value. After adjusting the effective co-pol EIRP density of the UT, an adjusted spectral efficiency of the UT can be determined resulting from the adjusting the EIRP density. Finally, an allocated bandwidth to the UT can be adjusted such that a resulting adjusted throughput of the UT at the adjusted spectral efficiency matches the baseline throughput.

### CROSS REFERENCE TO RELATED APPLICATIONS

This application claims priority to U.S. Provisional Patent Application No. 63/720,445, filed on Nov. 14, 2024, the disclosure of which is incorporated by reference in its entirety for all purposes.

### BACKGROUND

Cross polarization (x-pol) performance is an important performance parameter of antenna systems. X-pol performance can be expressed as cross-pol isolation (XPI). XPI is the difference between the signal power of intended polarization (co-pol) and that on the opposite polarization (x-pol), and can determine the interference caused by a user terminal (UT) transmitting in one polarization to another UT that is transmitting on the opposite polarization.

### SUMMARY

In some embodiments, a method for cross-polarization interference mitigation is provided. The method may comprise determining a baseline cross-polarization interference density limits of a user terminal (UT). The method can also include determining a baseline throughput of the user terminal. An adjustment value for an intended polarization (co-pol) isotropic radiated power (EIRP) density may be determined, such that the cross-polarization (x-pol) interference density limits are not exceeded. The method may further include, after determining the baseline throughput, adjusting an effective co-pol EIRP density of the UT based on the adjustment value. After adjusting the effective co-pol EIRP density of the UT, an adjusted spectral efficiency of the user terminal resulting from the adjusting the EIRP density can be determined. The method can also comprise adjusting an allocated bandwidth to the user terminal such that a resulting adjusted throughput of the user terminal at the adjusted spectral efficiency matches the baseline throughput.

Embodiments of such a method may include one or more of the following features, which may be separately combined with the method detailed above. The method may further comprise determining that the user terminal meets one or more adaptivity conditions, wherein the adjusting the EIRP, the determining the adjusted spectral efficiency, and the adjusting the allocated bandwidth are performed only when the user terminal meets the one or more adaptivity conditions. The one or more adaptivity conditions can comprise an azimuth-elevation-adaptive condition. The one or more adaptivity conditions may comprise an operationally adaptive condition. The one or more adaptivity conditions can also comprise a traffic-adaptive condition. The method may also comprise determining that one or more additional user terminals are nearby the UT and are using a same frequency with an opposite polarization. Adjusting the effective co-pol EIRP density of the UT based on the adjustment value can be based on determining that one or more additional user terminals are nearby the UT and are using the same frequency with the opposite polarization. The method can also include determining that a satellite supports multiple polarizations, wherein adjusting the effective co-pol EIRP density of the UT based on the adjustment value is performed based on determining that the satellite supports multiple polarizations. The method may further comprise determining that cross-polarization isolation is below a defined target value, wherein adjusting the effective co-pol EIRP density of the UT based on the adjustment value is performed based on determining that the cross-polarization isolation is below the defined target value.

In some embodiments, a system for cross-polarization interference mitigation is provided. The system may comprise a user terminal (UT). The system can also comprise a satellite gateway server system that is configured to communicate with the UT via a satellite. The system may be configured to determine a baseline cross-polarization interference density limits of the UT. The system can be configured to determine a baseline throughput of the user terminal. The system may also be configured to determine an adjustment value for an intended polarization (co-pol) isotropic radiated power (EIRP) density, such that the cross-polarization (x-pol) interference density limits are not exceeded. The system can be configured to, after determining the baseline throughput, adjust an effective co-pol EIRP density of the UT based on the adjustment value. The system may also be configured to, after adjusting the effective co-pol EIRP density of the UT, determine an adjusted spectral efficiency of the user terminal resulting from the adjusting the EIRP density. The system can further be configured to adjust an allocated bandwidth to the user terminal such that a resulting adjusted throughput of the user terminal at the adjusted spectral efficiency matches the baseline throughput.

Embodiments of such a system may include one or more of the following features, which may be separately combined with the system detailed above. The system may be further configured to determine whether the user terminal meets one or more adaptivity conditions, wherein the adjusting the EIRP, the determining the adjusted spectral efficiency, and the adjusting the allocated bandwidth are performed only when the user terminal meets the one or more adaptivity conditions. The one or more adaptivity conditions may comprise an azimuth-elevation-adaptive condition. The one or more adaptivity conditions may also comprise an operationally adaptive condition. The one or more adaptivity conditions can further comprise a traffic-adaptive condition. The system may also be further configured to determine that one or more additional user terminals are nearby the UT and are using a same frequency with an opposite polarization. The system being configured to adjust the effective co-pol EIRP density of the UT based on the adjustment value may be based on determining that one or more additional user terminals are nearby the UT and are using the same frequency with the opposite polarization. The system may be configured to determine that the satellite supports multiple polarizations, wherein adjusting the effective co-pol EIRP density of the UT based on the adjustment value is performed based on determining that the satellite supports multiple polarizations. The system can also be configured to determine that cross-polarization isolation is below a defined target value, wherein adjusting the effective co-pol EIRP density of the UT based on the adjustment value is performed based on determining that the cross-polarization isolation is below the defined target value. The system may further comprise the satellite. The satellite can communicate with a plurality of user terminals, which includes the user terminal, using left-hand circular polarization and right-hand circular polarization.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an illustrative end-to-end satellite communication system as a context for embodiments described herein.

FIG. 2 shows an example scenario of cross-polarization interference in an end-to-end satellite communication system.

FIG. 3 shows an XPI profile of a UT in which most of the XPI is higher than a specified target of 18 decibels (dB).

FIG. 4 shows a table of spectral efficiency achievable by a UT as a function of received signal-to-noise ratio (SNR).

FIG. 5 shows a flow diagram of an illustrative method for dynamic adaptive cross polarization interference mitigation, according to embodiments described herein.

FIG. 6 shows a plot of the interference power density of the Test UT after applying the mitigation technique, compared with the Reference UT (with an XPI of 18 dB).

FIG. 7 shows a plot of achievable data rates of the Test UT after applying the mitigation technique, compared with the Reference UT.

### DETAILED DESCRIPTION

Cross polarization (x-pol) performance is an important performance parameter of antenna systems, corresponding to cross-polarization interferences in the systems. X-pol performance can be expressed as cross-pol isolation (XPI), which is the difference between the signal power of intended polarization (co-pol) and that on the opposite polarization. For example, the co-pol polarization orientation can be left hand circularly polarization (LHCP) and the opposite (i.e., orthogonal) polarization orientation can be right hand circularly polarization (RHCP). In cases where signals are being sent on both polarization orientations using the same (or overlapping) frequency, XPI can determine the interference caused by a UT transmitting in one of the polarization orientations to a user terminal that is transmitting on the opposite polarization orientation. A lower XPI of a UT corresponds to the UT causing more interference to another UT transmitting on the opposite polarization orientation in the same frequency. Thus, it is desirable in antenna systems to reduce x-pol interference by increasing XPI, thereby improving x-pol performance.

While this document focuses on embodiments that use circular polarization, in other embodiments, linear polarization can be used. For example, vertical and horizontal polarization can be used for signal transmissions rather than clockwise or counterclockwise circular polarizations.

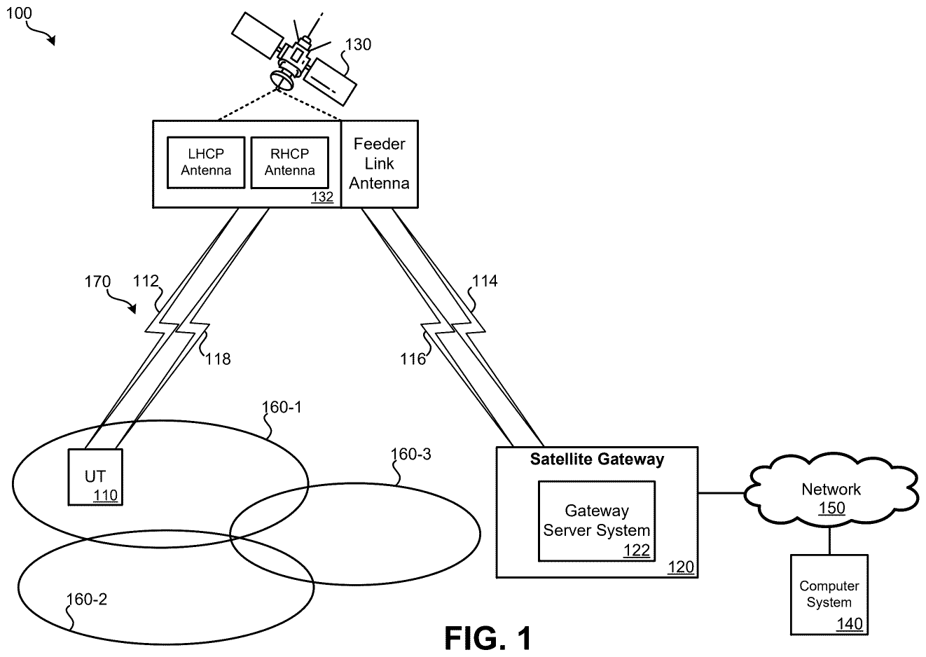

FIG. 1 illustrates a satellite communication system 100 (“system 100”) as an example context for embodiments described herein. As illustrated, system 100 includes a UT 110 in communication with satellite gateway 120 via one or more satellites, including satellite 130. UT 110 can be any form of device that communicates with one or more satellite, such as a satellite modem through which the Internet is accessed. Satellite 130 can be a low Earth orbit (LEO) satellite. In other embodiments, satellite 130 may be a middle Earth orbit (MEO) or geosynchronous (GEO) satellite. In the return-link direction, UT 110 transmits a user uplink signal 112 to satellite 130. Satellite 130 transmits a feeder downlink signal 114 to satellite gateway 120. Satellite gateway 120 can perform signal and data processing on feeder downlink signal 114 and transmit extracted data to a computer system 140 via network 150. In the forward direction, data from computer system 140 can be transmitted to satellite gateway 120 via network 150. Satellite gateway 120 transmits a feeder uplink signal 116 to satellite 130, and satellite 130 transmits a corresponding user downlink signal 118 to UT 110.

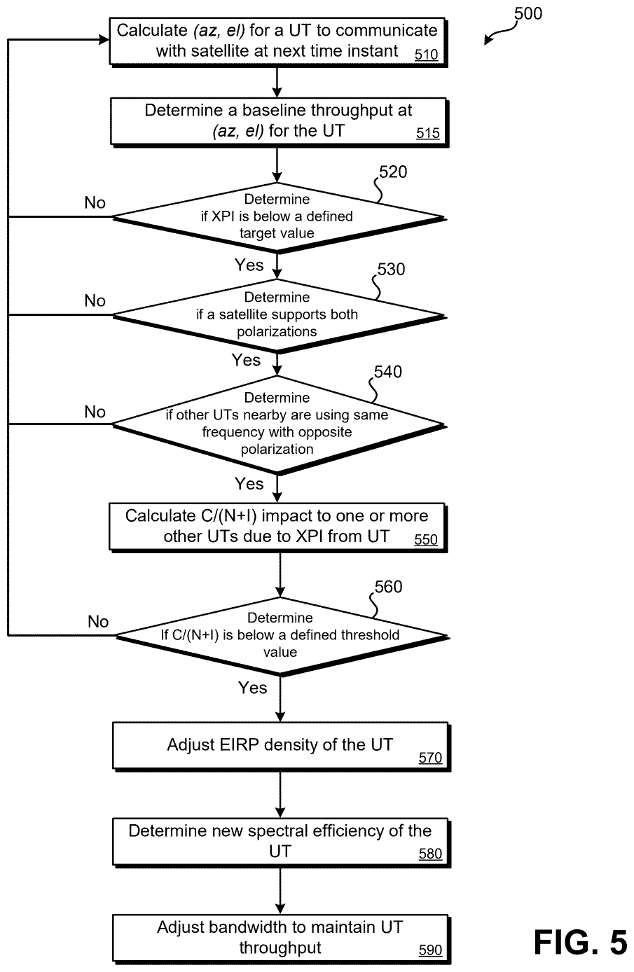

Satellite gateway 120 includes gateway server system 122, which can either be in communication with satellite gateway 120 or incorporated as part of satellite gateway 120. Gateway server system 122 can include one or more computer system. Gateway server system 122, as detailed in relation to FIG. 5, can perform various portions of a dynamic adaptive cross polarization interference mitigation process.

Satellite 130 can use spot beams to communicate with UTs in different geographical service areas. As an example, three spot beams 160 (160-1, 160-2, 160-3) are illustrated in FIG. 1; a real-world satellite communication system can use a larger number of spot beams 160. UT 110 is located within spot beam 160-1. Satellite 130 can include a satellite user link antenna 132 that supports both LHCP and RHCP in both the uplink and downlink directions. In some cases, one or more satellites of a satellite communication system supports only one polarization orientation in the user link or supports only one direction for each polarization orientation.

Interference mitigation techniques can be used to mitigate interference between the uplink and downlink traffic of a UT, such as UT 110. In some cases, the uplink and downlink communications use orthogonal polarization orientations (e.g., the uplink is LHCP and the downlink is RHCP), in which case, the uplink and downlink communications can share a same frequency (F). In some cases, the uplink and downlink communications use non-overlapping frequencies (e.g., F₁ and F₂), in which case they can share the same polarization orientation. In some cases (e.g., as illustrated), uplink signal 112 and downlink signal 118 communications between UT 110 and satellite 130 use orthogonal polarization orientations and non-overlapping frequencies.

UT has an antenna (not illustrated) for communicating with satellites, such as satellite 130. Embodiments described herein assume that there is at least some relative movement between UT locations and satellite locations. In some embodiments, such movement is due to a mobile terminal communicating with a GEO satellite. In other embodiments, such movement is due to a fixed-location UT communicating with a LEO or MEO satellite. In some cases, mobile terminals are in communication with a constellation of non-geosynchronous satellites.

In some embodiments, any cases of relative movement, maintaining communication link 170 (which includes uplink signals 112 and downlink signals 118) between UT 110 and satellite 130 can rely on UT 110 having an antenna that can have its antenna gain pattern be dynamically pointed in the direction of satellite 130. Some such antennas are mechanically steerable, such as by being mounted on electromechanical gimbals that physically change the pointing direction of satellite 130. Other such antennas are electronically steerable antennas (ESAs), which adjust amplitudes and phases of an array of antenna elements to electronically steer a signal's pointing direction.

To maintain pointing at a moving satellite, ESAs are designed to electronically steer their beams in an azimuthal direction (i.e., a 360-degree cone around the ESA) and in elevation (i.e., the angle from the horizon, corresponding to the width of the cone). ESAs tend to be designed with relatively good x-pol performance in its principal planes (e.g., horizontal and vertical planes). However, ESAs tend to not have good x-pol performance outside of the principal planes (e.g., along its diagonals) due to cross talk between the principal planes. For example, the horizontal and vertical planes tend to interact on the diagonals.

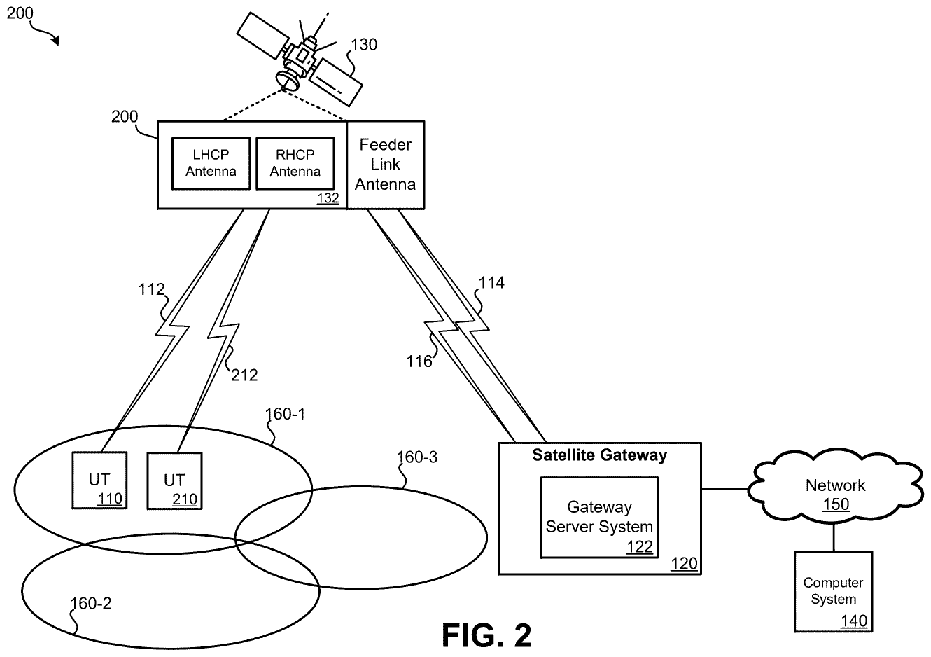

FIG. 2 illustrates an embodiment of cross-polarization interference in an end-to-end satellite communication system 200 (“system 200”). System 200 can represent an implementation of system 100 of FIG. 1, but with two UTs (110, 210) and only uplink signals (112, 212) illustrated. As in FIG. 1, UT 110 transmits user uplink signals 112 using LHCP and frequency F1. UT 210, which is nearby (e.g., in the same spot beam 160-1), is transmitting its user uplink signals 212 using RHCP and frequency F1. In theory, uplink signal 112 and uplink signal 212 will not interfere with each other even though both use frequency F1 because they are using orthogonal polarization orientations. However, practically, some amount of x-pol interference is expected by which LHCP communications of UT 112 can cause interference to RHCP communications of UT 212 and, similarly, RHCP communications of UT 212 can cause interference to LHCP communications of UT 112.

As an ESA scans to different scan angles and/or to different azimuths, its x-pol performance may appreciably degrade. As such, the x-pol interference between UT 110 and UT 210 can depend on the scan angles of one or both of UTs 110 and 210. As an example, suppose UT 210 has a fixed antenna that maintains a fixed beam pointing direction for communicating with satellite 130, which may be in GEO, but UT 110 has an ESA that dynamically steers its beam to follow a different satellite (e.g., in LEO). The amount of x-pol interference can appreciably change over time with changes in the scan angle of the ESA of UT 110. The resulting x-pol interference can be non-negligible in some cases.

Further, it should be understood that more than two UTs may be present. For example, in a particular environment, there may be 3, 4, or many more UTs present that each can cause some amount of x-pol interface to each other.

Some conventional efforts have considered using physical and electromagnetic changes to the ESA design to improve x-pol performance, such as by increasing aperture size, using advanced materials, etc. However, such conventional efforts tend to appreciably increase the cost, complexity, and/or footprint of the ESA, which may be impractical or undesirable in many cases. Embodiments herein seek to minimize the effects of x-pol interference in an adaptive manner without changing the underlying ESA design.

Based on the above, a higher XPI is desired to minimize interference in the opposite polarization. LEO satellite systems preferably use UTs with ESA to track the moving satellites in the constellation. These ESA-based user terminals are typically designed to scan the entire 360 degrees of azimuth angles and low elevation angles to maintain communication with one or more satellites in the constellation. Achieving high XPI, especially in dual-polarized, wide-scan, low-cost phased-array antenna systems can be challenging. This is especially true in azimuth angles corresponding to diagonal or inter-cardinal planes and low elevation angles. This implies that the level of interference in the opposite polarization for these azimuth angles and elevation angles will tend to be higher than desired values.

As described above, the XPI essentially represents an amount of power from one UT's transmission that leaks into a nearby UT's transmissions thereby causing x-pol interference. An XPI_target can be defined to represent a target XPI of a particular UT antenna (or of all UTs in a system, or of all of a certain type or group of UTs in a system). XPI_target is typically chosen such that the interference power in the opposite polarization is below a predefined threshold. The threshold value for interference power is determined based on spectral efficiency that is needed to be achieved for UTs operating in the opposite polarization. A higher spectral efficiency correlates to a lower tolerable interference threshold.

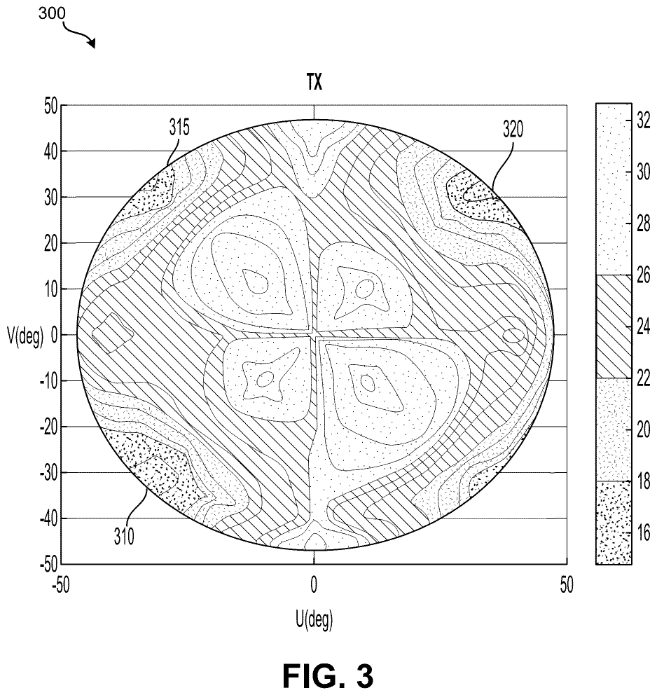

For the sake of illustration, FIG. 3 illustrates an XPI profile 300 of a UT (e.g., UT 110) in which most of the XPI is higher than a specified target of 18 decibels (dB). As illustrated, the XPI is relatively good in the horizontal and vertical directions, but the XPI is appreciably worse in the diagonal directions, particularly at low elevation angles. In particular, regions of scan angles where the XPI is lower than the target XPI (i.e., below 18 dB) are roughly indicated by region 310, region 315, and region 320.

Emax can be defined as the maximum effective isotropic radiated power (EIRP) of a given UT with an ESA. This maximum is typically achieved when the ESA is scanning at the boresight of the antenna plane. E(az, el) can define the EIRP achieved by a UT when its ESA scans away from the boresight. Here, az represents the azimuth angle and el represents the elevation angle of the scan. The amount of bandwidth over which the UT EIRP can be transmitted is dictated by the maximum EIRP density that the UT is permitted for a given scan angle of (az, el). Maximum EIRP density is typically determined based regulatory restrictions to minimize interference to satellites from other constellations (including GEO satellites).

Suppose EDₘₐₓ(az, el) represents the maximum EIRP density that a UT can transmit in a given (az, el). This EDₘₐₓ(az, el) is independent of UT type. For a UT that is capable of transmitting an EIRP density of EDₘₐₓ(az, el) as well as satisfying the regulatory constraints and satisfying the XPI_target, the x-pol interference power density caused in the opposite polarization in the direction of (az, el) is given by:

$$P {x}_{max} = E {D}_{max} ( az , el ) - X P {I}_{target} \qquad ( 1 )$$

A goal of embodiments described herein may be to ensure that the x-pol interference power density will be less than Pxₘₐₓ from a given UT. This can be achieved if XPI from a given UT is higher than XPI_{target}. However, for ESA-based user terminals, this may not always be the case, especially in the inter-cardinal planes for low elevation angles. In such a situation, the interference power from this UT will be higher than Pxₘₐₓ equation (1) above.

Embodiments can provide a technique to ensure that the interference power density from UTs is always lower than the Pxₘₐₓ threshold of equation (1). With such an implementation, the effective XPI from a given UT will always be higher than XPI_{target}.

Let y(az, el) dB be the XPI of the UT antenna system at (az, el), which is varying as scan angle (az, el). Therefore, x-pol interference density Px is also a function of scan angle and is given by:

$$P x ( az , el ) = E {D}_{max} ( az , el ) - y ( az , el ) \qquad ( 2 )$$

This can be rewritten as:

$$P x ( az , el ) = P {x}_{max} + {Xcross}_{adj} \qquad ( 3 )$$

where Xcross_{adj}=XPI_{target}−y az, el).

If y(az, el) is higher than XPI_{target}, the x-pol interference Px(az, el) will be lower than Pxₘₐₓ. But if y(az, el) is lower than XPI_{target}, Xcross_{adj} would be positive. Thus, x-pol interference from this UT will be higher than what is allowed.

To limit the x-pol interference density such that it is always under Pxₘₐₓ it is proposed here that the UT's co-pol EIRP density ED_{UT}(az, el) can be adjusted for this scan angle (az, el) as:

$$E {D}_{UT} ( az , el ) = E {D}_{max} ( az , el ) - max ( {Xcross}_{adj} , 0 ) \qquad ( 4 )$$

The cross-pol interference from this UT will then be:

$$P x ( az , el ) = E {D}_{max} ( az , el ) - max ( {Xcross}_{adj} , 0 ) - y ( az , el ) \qquad ( 5 )$$

It can be seen that the x-pol interference from equation (5) is always less than or equal to Pxₘₐₓ shown in equation (1). Compared to a UT with target XPI_{target}, no additional interference is introduced by UTs whose XPI performance is lower than XPI_{target} for certain angles. By adjusting co-pol EIRP density via equation (4), an effective minimum XPI_{target} is ensured. All UTs in the system will be operating with an effective x-pol interference power density of better than Pxₘₐₓ, thus causing no more additional interference to the system than would be caused by a UT that satisfies XPI_{target} requirement.

In the above equations, it is assumed that the ESA performance is such that EDₘₐₓ(az, el) can be transmitted by the UT without causing regulatory issues with other constellations. Some ESA designs may be such that the UT would need to further reduce the EIRP density due to regulatory restrictions with other constellations. Suppose that the maximum EIRP density for an ESA-based UT is denoted by ED_{UTmax}(az, el) such that it can satisfy regulatory concerns for inter-constellation interference. Let ED_{UTmax}(az, el)=EDₘₐₓ(az, el)−z(az, el). In such a case, Px(az, el)=ED_{UTmax}(az, el)−y(az, el). This can be re-written as Px(az, el)=EDₘₐₓ(az, el)−z(az, el)−y(az, el).

In this scenario, Xadjust can be defined as Xadjust=XPI_{target}−z(az, el)−y(az, el). Based on that relationship, ED_{UT}(az, el) can be adjusted as:

$$E {D}_{UT} ( az , el ) = E {D}_{UTmax} ( az , el ) - max ( Xadjust , 0 ) \qquad ( 6 )$$

It can be seen that the x-pol interference density is given by: Px(az, el)=ED_{UT}(az, el)−y(az, el), or equivalently:

$$P x ( az , el ) = E {D}_{max} ( az , el ) - z ( az , el ) - max ( Xadjust , 0 ) - Y ( az , el ) \qquad ( 7 )$$

It can be seen that Px(az, el) in equation (7) is always less than Pxₘₐₓ defined in equation (1), thereby satisfying the intended objective.

It is noted that, although adjusting the EIRP density of the terminal as indicated in equations (5) or (6) can lower the spectral efficiency, the approach described herein has a negligible impact on data rate because the adjustment is to EIRP density, not to EIRP itself. Said differently, reduction of co-pol EIRP density of UT 110 in order to mitigate x-pol interference to UT 210 does not necessarily impact the user terminal throughput of UT 110.

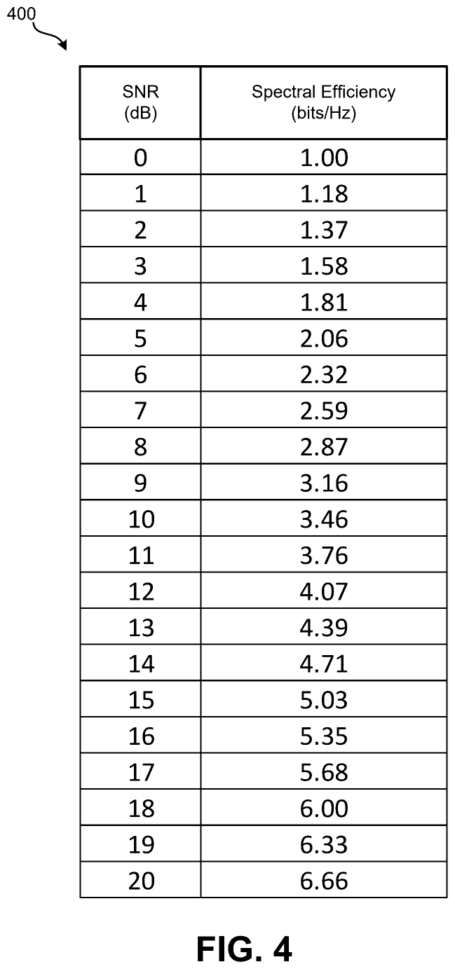

To help illustrate this, FIG. 4 illustrates a table 400 of spectral efficiency achievable by a UT as a function of received signal-to-noise ratio (SNR). Received SNR has a one-to-one relationship with the transmitted EIRP density in an interference free environment. Suppose as a baseline (i.e., without applying embodiments described herein, such as without applying equation (4) or (6)) that UT 110 was achieving a spectral efficiency of 2.59 bits/Hz at an SNR of 7 dB. Suppose further that the EIRP density needed to achieve an SNR of 7 dB is −25 dBW/Hz. If UT 110 is transmitting over a bandwidth of 1 MHz, the corresponding throughput for UT 110 is 2.59 Mbps. With an EIRP density of −25 dBW/Hz, UT 110 is transmitting a total of 35 dBW of EIRP over 1 MHz.

The adjustment in equation (4) or (6) can be applied to yield an adjustment of 2 dB. This implies that the EIRP density will drop to −27 dBW/Hz. The EIRP over 1 MHz correspondingly drops to 33 dBW. According to table 400, a drop of 2 dB in SNR corresponds to the spectral efficiency dropping from 2.59 bits/Hz to 2.06 bits/Hz (i.e., at 5 dB receiver SNR). Therefore, the throughput of UT 110 over 1 MHz similarly drops to 2.06 Mbps.

Embodiments can increase the bandwidth allocated to UT 110 from 1 MHz to 1.26 MHz. If UT 110 transmits over 1.26 MHz, the throughput of UT 110 will be 2.06 bits/Hz×1.26 MHz=2.59 Mbps, which is equivalent to the throughput achieved without the EIRP density adjustment. In such a case, the total EIRP transmitted by UT 110 over 1.26 MHz is 34 dBW, which is less than the 35 dBW without the proposed EIRP density adjustment. Thus, it can be seen that applying x-pol mitigation techniques described herein can mitigate the effects of x-pol interference without reducing UT throughput and with lower transmitted EIRP.

In some embodiments, it is desirable only to apply x-pol interference mitigation where needed. The EIRP density control approaches described herein are very flexible, such that the operator can determine when to apply the mitigation and can selectively apply the mitigation only where selected. For example, the x-pol mitigation technique can be applied to certain (az, el) combinations for which the XPI of a particular UT is determined to be less than a predetermined XPI_{target}, referred to herein as “azel-adaptive.” Such a selective invocation can be performed locally in the UT, or via a remote configuration of the UT from an external server.

Some embodiments apply azel-adaptive (and/or other adaptive) approaches to mobile UTs. Mobile UTs can use position and heading information to determine the scan angle (az, el) of its antenna to the satellite with which it is communicating. The UT can also be aware of its own XPI performance as a function of its (az, el). Therefore, the mobile UT can adjust its EIRP density (e.g., based on equations (4) and (6)) in an azel-adaptive manner.

Some embodiments can additionally or alternatively be selectively invoked by the operator depending on the operational scenario of the network, referred to herein as “operationally adaptive.” In one scenario, an operator may initially have a satellite constellation that operates on a single polarization but has future plans to introduce the opposite polarization. In this scenario, EIRP density adjustment embodiments described herein can be invoked in an operationally adaptive manner as satellites with opposite polarization orientations are introduced. Even after such satellites are introduced, embodiments can be advantageously invoked in only those cases where there exists another UT in the same location as the UT of interest and operating in the opposite polarization orientation, but the same frequency as the UT of interest.

Some embodiments can additionally or alternatively be selectively invoked if there exists another UT in the same location as UT of interest, operating in the opposite polarization but same frequency as the UT of interest, and the victim UT is in a session that requires higher order modulation and therefore higher efficiency or higher SNR, referred to herein as “traffic adaptive.” For example, if the victim UT is in a narrowband session such as voice or IOT that can operate at lower SNR, then such sessions ac more forgiving to cross-pol interference and therefore, there is no need to invoke this feature.

Embodiments can generally be referred to as performing “adaptive” x-pol mitigation. As used herein, “adaptive” can include any one or more of azel-adaptive, operationally adaptive, and/or traffic adaptive implementations.

Using the systems and arrangements detailed in relation to FIGS. 1-4, various methods can be performed. FIG. 5 illustrates an embodiment of a method 500 for dynamic adaptive cross polarization interference mitigation. Method 500 can, for example, be performed in a satellite-based system similar to system 200 of FIG. 2. At block 510, calculation of (az, el) for a UT (e.g., UT 110) to communicate with a satellite of interest (with which it is communicating or is scheduled to communicate) at a next time instant is performed, and the XPI at that (az, el) is determined. In some embodiments (azel-adaptive embodiments), a determination is made as to whether the XPI at that (az, el) is below a predetermined XPI_{target} at block 520. The determination can be made by the UT or remotely by a gateway server system. If not, the method 500 can end or return to the start. If returning to block 510, a pause may be performed before method 500 is repeated. The calculation of block 510 can be performed by the UT. The calculation can also be performed by a remote system such as a satellite gateway system.

At block 515, a baseline throughput can be determined for the UT at (az, el). This baseline throughput is for the UT without an EIRP density adjustment.

If the XPI at the calculated (az, el) is below the predetermined XPI_{target}, in some embodiments (operationally adaptive embodiments), a further determination is made as to whether the satellite of interest supports multiple (e.g., both) polarization orientations at block 530 by the UT or remotely by the gateway server system. If not, method 500 can return to the start or end. If the satellite of interest supports multiple (e.g., both) polarization orientations, method 500 can proceed to block 540. At block 540, a further determination may be made as to whether there are other UTs (e.g., UT 210) near the UT (e.g., UT 110) using the same frequency but a different supported polarization orientation. If not, the method 500 can end or can return to the start. Block 540 can be performed directly by the gateway server system based in part on data received from other UTs or stored indications of locations.

If the prior conditions are met, in some embodiments (e.g., traffic adaptive embodiments), embodiments can calculate a carrier-to-noise-plus-interference ratio (C/(N+I)) at block 550. Block 550 can be performed directly by the gateway server system. A further determination can be made at block 560 as to whether the carrier-to-noise-plus-interference ratio is below a predetermined threshold ratio. In this computation and determination, ‘C’ represents the strength of the desired signal or carrier signal, ‘N’ represents the level of background noise present in the communication channel, and ‘I’ represents the level of unwanted signals or interference from other sources that may affect the communication channel; such that the ratio essentially represents a quality of a communication link. If the carrier-to-noise-plus-interference ratio is not below the predetermined threshold ratio, method 500 can end or return to the start of method 500. Block 560 can be performed directly by the gateway server system.

Though not explicitly shown, one or more additional adaptivity determinations can be made as part of method 500. For example, in an embodiment where blocks 540 and/or 560 are not performed, other adaptivity determinations can be performed to determine if method 500 should proceed. If all the adaptivity determinations are satisfied, the method 500 can apply x-pol mitigation, as described herein. Method 500 can adjust EIRP density of the UT at block 570 by the UT based on an adjustment value. The adjustment value can be calculated as detailed in relation to equations 4 or 6. The UT can perform the adjustment in response to a received command from the gateway server system. At the new EIRP density, a resulting spectral efficiency of the UT can be determined at block 580. The bandwidth allocated to the UT to maintain the throughput of the UT to its level prior to applying the adjustment can be adjusted at block 590. Blocks 580 and 590 can be performed by the gateway server system. Following block 590, possibly after a defined period of time, method 500 can repeat.

For added clarity, an example is provided for results of a simulated comparison between the x-pol interference introduced from a “Reference UT” that meets the XPI_{target} (18 dB in the simulated example) for all scan angles, and a “Test UT” whose XPI meets or exceeds the XPI_{target} for most scan angles but is less than XPI_{target} for the remaining scan angles. The simulation places the Test UT and the Reference UT at the same location in a LEO satellite communication system. Referring back to FIG. 3, the illustrated XPI profile 300 is the XPI profile for the Test UT with black borders showing scan angles where XPI is lower than XPI_{target}.

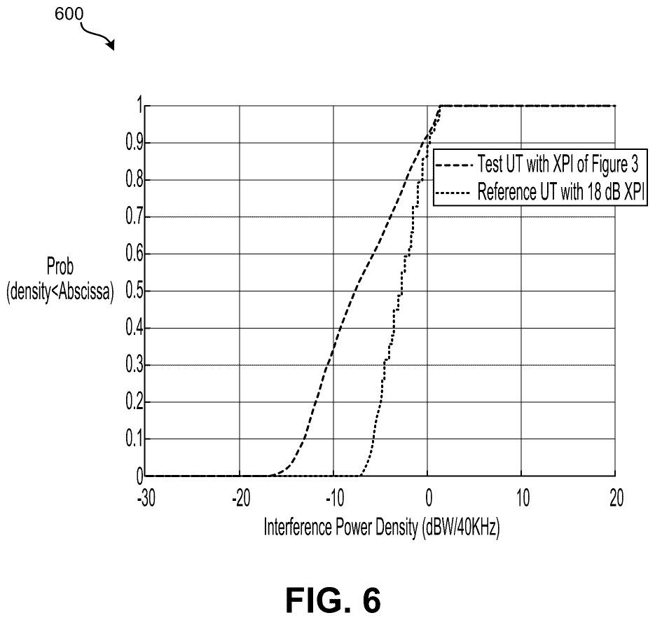

FIG. 6 illustrates a plot 600 of the interference power density of the Test UT after applying the mitigation technique, compared with the Reference UT (with an XPI of 18 dB). FIG. 6 shows that the interference power density of the Test UT is always better than the hypothetical Reference UT. The Test UT behaves as though the effective cross-polarization performance is always higher than 18 dB when the proposed technique is applied.

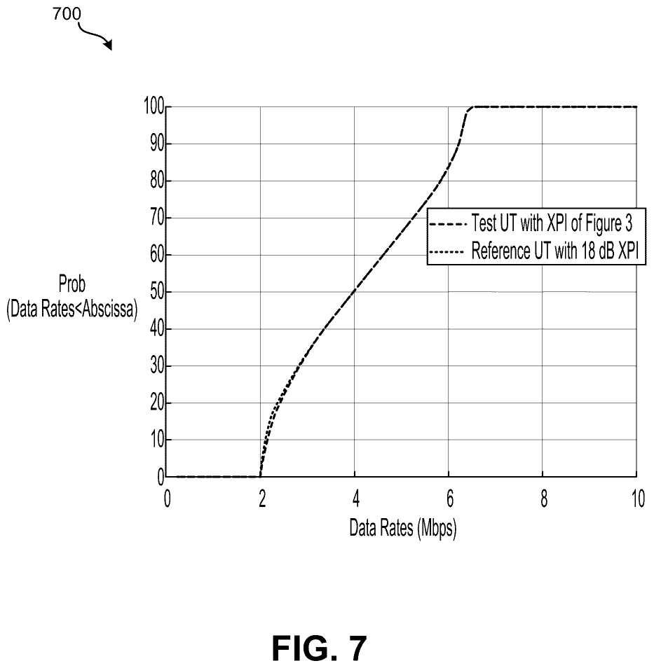

FIG. 7 shows a plot 700 of data rates of the Test UT after applying the mitigation technique, compared with the Reference UT. FIG. 7 demonstrates that the application of EIRP density control, as described herein, has no or minimum impact on achieved data rates. (For clarity, in FIG. 7, the two plotted lines nearly perfectly overlap.)

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for cross-polarization interference mitigation comprising:
determining a baseline cross-polarization interference density limits of a user terminal (UT);
determining a baseline throughput of the user terminal;
determining an adjustment value for an intended polarization (co-pol) isotropic radiated power (EIRP) density, such that the cross-polarization (x-pol) interference density limits are not exceeded;
after determining the baseline throughput, adjusting an effective co-pol EIRP density of the UT based on the adjustment value;
after adjusting the effective co-pol EIRP density of the UT, determining an adjusted spectral efficiency of the user terminal resulting from the adjusting the EIRP density; and
adjusting an allocated bandwidth to the user terminal such that a resulting adjusted throughput of the user terminal at the adjusted spectral efficiency matches the baseline throughput.

2. The method of claim 1, further comprising:
determining that the user terminal meets one or more adaptivity conditions, wherein the adjusting the EIRP, the determining the adjusted spectral efficiency, and the adjusting the allocated bandwidth are performed only when the user terminal meets the one or more adaptivity conditions.

3. The method of claim 1, further comprising:
determining that one or more additional user terminals are nearby the UT and are using a same frequency with an opposite polarization.

4. The method of claim 3, wherein adjusting the effective co-pol EIRP density of the UT based on the adjustment value is based on determining that one or more additional user terminals are nearby the UT and are using the same frequency with the opposite polarization.

5. The method of claim 1, further comprising:
determining that a satellite supports multiple polarizations, wherein adjusting the effective co-pol EIRP density of the UT based on the adjustment value is performed based on determining that the satellite supports multiple polarizations.

6. The method of claim 1, further comprising:
determining that cross-polarization isolation is below a defined target value, wherein adjusting the effective co-pol EIRP density of the UT based on the adjustment value is performed based on determining that the cross-polarization isolation is below the defined target value.

7. The method of claim 2, wherein the one or more adaptivity conditions comprises an azimuth-elevation-adaptive condition.

8. The method of claim 2, wherein the one or more adaptivity conditions comprises an operationally adaptive condition.

9. The method of claim 2, wherein the one or more adaptivity conditions comprises a traffic-adaptive condition.

10. A system for cross-polarization interference mitigation, the system comprising:
a user terminal (UT); and
a satellite gateway server system that is configured to communicate with the UT via a satellite, the system configured to:
determine a baseline cross-polarization interference density limits of the UT;
determine a baseline throughput of the user terminal;
determine an adjustment value for an intended polarization (co-pol) isotropic radiated power (EIRP) density, such that the cross-polarization (x-pol) interference density limits are not exceeded;
after determining the baseline throughput, adjust an effective co-pol EIRP density of the UT based on the adjustment value;
after adjusting the effective co-pol EIRP density of the UT, determine an adjusted spectral efficiency of the user terminal resulting from the adjusting the EIRP density; and
adjust an allocated bandwidth to the user terminal such that a resulting adjusted throughput of the user terminal at the adjusted spectral efficiency matches the baseline throughput.

11. The system of claim 10, wherein the system is further configured to:
determine whether the user terminal meets one or more adaptivity conditions,
wherein the adjusting the EIRP, the determining the adjusted spectral efficiency, and the adjusting the allocated bandwidth are performed only when the user terminal meets the one or more adaptivity conditions.

12. The system of claim 10, wherein the system is further configured to:
determine that one or more additional user terminals are nearby the UT and are using a same frequency with an opposite polarization.

13. The system of claim 12, wherein the system being configured to adjust the effective co-pol EIRP density of the UT based on the adjustment value is based on determining that one or more additional user terminals are nearby the UT and are using the same frequency with the opposite polarization.

14. The system of claim 10, wherein the system is configured to:
determine that the satellite supports multiple polarizations, wherein adjusting the effective co-pol EIRP density of the UT based on the adjustment value is performed based on determining that the satellite supports multiple polarizations.

15. The system of claim 10, wherein the system is configured to:
determine that cross-polarization isolation is below a defined target value, wherein adjusting the effective co-pol EIRP density of the UT based on the adjustment value is performed based on determining that the cross-polarization isolation is below the defined target value.

16. The system of claim 10, wherein the one or more adaptivity conditions comprises an azimuth-elevation-adaptive condition.

17. The system of claim 10, wherein the one or more adaptivity conditions comprises an operationally adaptive condition.

18. The system of claim 10, wherein the one or more adaptivity conditions comprises a traffic-adaptive condition.

19. The system of claim 10, further comprising the satellite.

20. The system of claim 10, wherein the satellite communicates with a plurality of user terminals, which includes the user terminal, using left-hand circular polarization and right-hand circular polarization.
